(19) United States
(12) Patent Application Publication
(10) Pub. No.: US 2026/0350720 A1
(43) Pub. Date: Nov. 5, 2026

(54) ENERGY OPERATION MANAGEMENT APPARATUS AND ENERGY OPERATION MANAGEMENT METHOD

(71) Applicant: Mitsubishi Electric Corporation, Tokyo (JP)

(72) Inventors: Shota YUMIKI, Tokyo (JP); Kazuhiro YASUNAMI, Tokyo (JP); Shoichi KITAMURA, Tokyo (JP)

(73) Assignee: Mitsubishi Electric Corporation, Tokyo (JP)

(21) Appl. No.: 19/473,813

(22) PCT Filed: May 11, 2023
(86) PCT No.: PCT/JP2023/017718

§ 371 Date: Oct. 9, 2025

(51) Int. Cl. G06Q 50/06; H02J 3/00; H02J 101/20; H02J 103/40; H02J 103/50

(52) U.S. Cl. CPC G06Q 50/06; H02J 3/003; H02J 3/004; H02J 2101/20; H02J 2103/40; H02J 2103/50

(57) ABSTRACT

An object of the present disclosure is to make an energy operation plan in consideration of a peculiar event. A first event prediction part predicts whether a peculiar event occurs in a first period based on storage data. A first prediction data creation part predicts at least any one of an energy price, an energy demand, and generated electrical power in the first period based on the storage data and first event prediction data. A first problem creation part creates a first optimization problem based on the storage data and first prediction data. A second prediction data creation part predicts at least any one of an energy price, an energy demand, and generated electrical power in a second period based on the storage data. A second problem creation part creates a second optimization problem based on the storage data, second prediction data, and the first operation plan.

### TECHNICAL FIELD

The present disclosure relates to creation of energy operation plan.

### BACKGROUND ART

Recently, generation of electrical power using renewable energy such as photovoltaics (PV) or wind-power generation, for example, attracts attention toward achievement of decarbonized society. However, since output of the renewable energy is significantly changed depending on weather, it is difficult to maintain a demand-supply balance. When the output of the renewable energy is suppressed, the demand-supply balance can be maintained. However, such a configuration is not reasonable from a viewpoint of economical use of the energy.

Conventionally, surplus electrical power of the renewable energy is generally stored in a storage cell to deal with this problem. However, the storage cell can deal with frequently output change of the renewable energy and can instantaneously output the energy, but has a problem that it cannot store large volumes of energy. Thus, desired is development of a technique of efficiently use surplus electrical power of renewable energy.

Patent Document 1 focuses on a technique of performing electrolysis on water using surplus electrical power of renewable energy to generate hydrogen, storing hydrogen in a tank, and generating electrical power using a fuel cell, for example, using hydrogen as a fuel in a different period of time. Hydrogen storage has a defect that electrical power cannot be instantaneously outputted compared with a storage cell and there is large loss in energy conversion by a fuel cell, but can store large volumes of energy for a long period of time. Thus, Patent Document 1 proposes an electrical power supply system in which a storage cell and hydrogen storage are used together to complement their defects, and a recharge-discharge plan is made in consideration of change of a demand-supply balance of both a short period of time (twenty-four hours) and a long period of time (seven days). According to the electrical power supply system, a reverse power flow can be suppressed, and a local production and consumption of the electrical power can be achieved.

Patent Document 2 proposes a plant control apparatus which can be automatically controlled so that hydrogen or ammonia, for example, can be manufactured using renewable energy and a manufactured material is sold when its price is higher. According to the plant control apparatus, an economic value of the manufactured material can be further increased.

### PRIOR ART DOCUMENTS

### Patent Document(s)

Patent Document 1: Japanese Patent Application Laid-Open No. 2016-111871

Patent Document 2: U.S. Pat. No. 7,027,623 in Patent Gazette

### SUMMARY

### Problem to Be Solved by the Invention

The technique disclosed in Patent Document 1 has a problem that an energy price of electrical power or gas, for example, in market is not considered in planning of generating hydrogen from the surplus electrical power of the renewable energy; thus an energy operation plan cannot be made in consideration of economic efficiency.

In the technique disclosed in Patent Document 2, the surplus electrical power of the renewable energy is effectively used in consideration of the energy price in market. However, an energy price, demand, and renewable energy output in market several months ahead (long period of time) are significantly influenced by abnormal weather such as typhoon, El Nino phenomenon, or La Nina phenomenon, for example. The technique disclosed in Patent Document 2 does not take into consideration an energy price change in market caused by a peculiar event such as the abnormal weather, demand change, or output change of the renewable energy, thus has a problem that an energy operation plan cannot be made in consideration of economic efficiency in a long period of time.

The present disclosure is to solve the above problems, and an object is to make an energy operation plan in consideration of a peculiar event.

### Means to Solve the Problem

An energy operation management apparatus according to the present disclosure creates an operation plan of a plurality of energy supply apparatuses supplying energy to a consumer group using generated electrical power in a renewable energy facility and energy bought from an energy market. The energy operation management apparatus according to the present disclosure includes a data acquisition part, a first event prediction part, a first prediction data creation part, a first problem creation part, a first solution part, a second prediction data creation part, a second problem creation part, a second solution part, and an output part. The data acquisition part acquires storage data including an actual value of an energy price in the energy market, an energy demand of the consumer group, generated electrical power of the renewable energy facility, and weather data, and makes a storage part store the storage data. The first event prediction part predicts whether a peculiar event as a phenomenon having influence on at least any one of the energy price, the energy demand, and the generated electrical power occurs in a first period based on the storage data. The first prediction data creation part predicts at least any one of the energy price, the energy demand, and the generated electrical power in the first period based on the storage data and first event prediction data as a prediction result of the first event prediction part. The first problem creation part creates a first optimization problem for determining a first operation plan as an operation plan of the plurality of energy supply apparatuses in the first period based on the storage data and first prediction data as a prediction result of the first prediction data creation part. The first solution part acquires a solution of the first optimization problem, thereby determining the first operation plan. The second prediction data creation part predicts at least any one of the energy price, the energy demand, and the generated electrical power in a second period shorter than the first period based on the storage data. The second problem creation part creates a second optimization problem for determining a second operation plan as an operation plan of the plurality of energy supply apparatuses in the second period based on the storage data, second prediction data as a prediction result of the second prediction data creation part, and the first operation plan. The second solution part acquires a solution of the second optimization problem, thereby determining the second operation plan. The output part performs an energy purchase request to the energy market based on the second operation plan and transmits instruction of an operation to the plurality of energy supply apparatuses.

### Effects of the Invention

The energy operation management apparatus according to the present disclosure determines the first operation plan in consideration of the peculiar event which may occur in the first period, and determines the second operation plan as the energy operation plan in the second period based on the first operation plan. According to the energy operation management apparatus of the present disclosure, the energy operation plan can be determined in consideration of the peculiar event. These and other objects, features, aspects and advantages of the present disclosure will become more apparent from the following detailed description when taken in conjunction with the accompanying diagrams.

### BRIEF DESCRIPTION OF DRAWINGS

FIG. 1 is a diagram illustrating a configuration of an energy operation management system according to an embodiment 1.

FIG. 2 is a diagram illustrating a configuration of an energy operation management apparatus according to the embodiment 1.

FIG. 3 is a diagram illustrating prediction data of an electrical power demand by a single scenario.

FIG. 4 is a diagram illustrating prediction data of an electrical power demand by a plurality of scenarios.

FIG. 5 is a flow chart illustrating an operation of the energy operation management apparatus according to the embodiment 1.

FIG. 6 is a diagram illustrating a type of input and output of each apparatus of an energy supply system.

FIG. 7 is a diagram illustrating a connection relationship of each apparatus of the energy supply system.

FIG. 8 is a diagram illustrating a configuration of an energy operation management apparatus according to an embodiment 2.

FIG. 9 is a flow chart illustrating an operation of the energy operation management apparatus according to the embodiment 2.

FIG. 10 is a diagram illustrating a configuration of an energy operation management system according to an embodiment 3.

FIG. 11 is a diagram illustrating a configuration of an energy operation management apparatus according to the embodiment 3 applied when a carbon tax is introduced.

FIG. 12 is a diagram illustrating a configuration of the energy operation management apparatus according to the embodiment 3 applied when a CO2 cap-and-trade system is introduced.

FIG. 13 is a diagram illustrating a trade of a carbon discharge amount between areas A and B via a carbon discharge amount management system.

FIG. 14 is a diagram illustrating a configuration of an energy operation management system according to an embodiment 4.

FIG. 15 is a diagram illustrating a configuration of an energy operation management apparatus according to the embodiment 4 applied when a carbon tax is introduced.

FIG. 16 is a diagram illustrating a configuration of the energy operation management apparatus according to the embodiment 4 applied when a CO2 cap-and-trade system is introduced.

FIG. 17 is a diagram illustrating a hardware configuration of the energy operation management apparatus.

FIG. 18 is a diagram illustrating a hardware configuration of the energy operation management apparatus.

### DESCRIPTION OF EMBODIMENT(S)

### A. Embodiment 1

### Whole Configuration

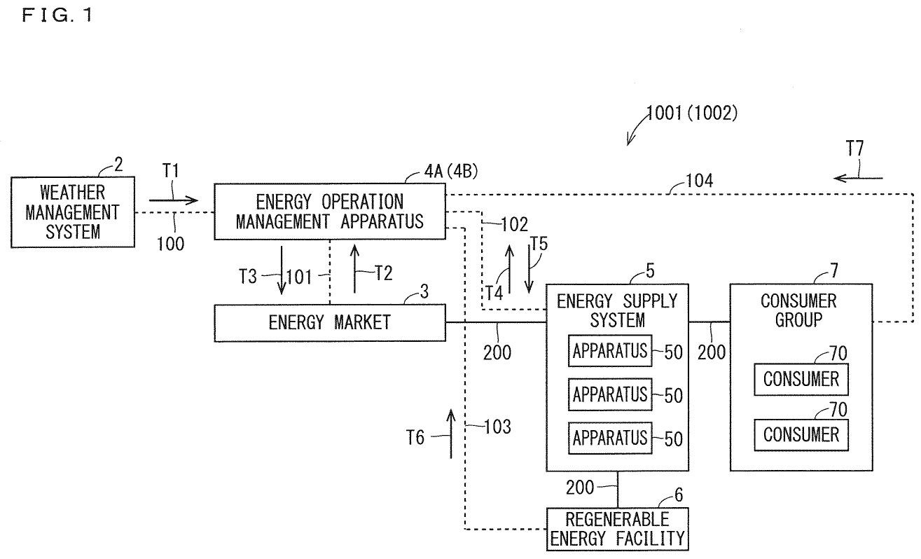

FIG. 1 illustrates a configuration of an energy operation management system 1001 according to an embodiment 1.

The energy operation management system 1001 includes a weather management system 2, an energy market 3, an energy operation management apparatus 4A, an energy supply system 5, a renewable energy facility (referred to as “renewable energy facility” hereinafter) 6, and a consumer group 7. The energy operation management apparatus 4A is connected to the weather management system 2, the energy market 3, a plurality of apparatuses 50 included in the energy supply system 5, the renewable energy facility 6, and a consumer 70 constituting the consumer group 7 via communication networks 100, 101, 102, 103, and 104, respectively.

The energy supply system 5 includes the plurality of apparatuses 50 as energy supply apparatuses. Although FIG. 1 illustrates three apparatuses 50, the number of the apparatuses 50 included in the energy supply system 5 is not limited thereto, and one or the plurality of apparatuses 50 may be applicable.

The renewable energy facility 6 is a facility generating electrical power using renewable energy.

The consumer group 7 includes the plurality of consumers 70. Although FIG. 1 illustrates two consumers 70, the number of the consumers 70 constituting the consumer group 7 is not limited thereto, and one or the plurality of the consumers 70 may be applicable.

The energy supply system 5 is physically connected to each of the energy market 3, the renewable energy facility 6, and the consumer group 7 by an infrastructure facility 200 such as an electrical power system or a gas pipe. Each element constituting the energy operation management system 1001 is described hereinafter.

### Weather Management System 2

The weather management system 2 predicts future weather data at a certain point, and supplies a predicted value of the weather data to the energy operation management apparatus 4A. The weather data predicted by the weather management system 2 includes a temperature, a wind speed, a wind direction, a precipitation amount, a snowfall amount, an atmospheric pressure, a solar radiation amount, or a cloud amount, for example.

The weather management system 2 acquires an actual value of the weather data every several hours or minutes at an observation point, and supplies the actual value to the energy operation management system 4A. The weather management system 2 acquires the actual value of the weather data from a measurement apparatus disposed in an observation point, for example.

The weather management system 2 predicts the weather data several weeks, hours, or minutes ahead. Alternatively, the weather management system 2 may predict the weather data further ahead than several weeks. For example, the weather management system 2 may predict occurrence of a typhoon in coming several weeks. The weather management system 2 may predict the weather data in a period across seasons such as predicting summer weather data in the spring or winter weather data in the fall.

The weather management system 2 may predict a renewable energy output, particularly a power generation amount of PV several months ahead while predicating the weather several months ahead. When El Nino phenomenon occurs, there is a tendency that a temperature is low and a day length decreases in a summer season, and a temperature is high in a winter season near Japan. In the meanwhile, when La Nina phenomenon occurs, there is a tendency that a temperature is high in a summer season and is low in a winter season near Japan. Thus, the weather management system 2 may predict occurrence of El Nino phenomenon or La Nina phenomenon. Such events have a large influence on consumption energy of the consumer 70, an output of the renewable energy facility 6, and an energy price in the energy market 3, and are referred to as a peculiar event in the present specification. The weather management system 2 supplies peculiar event information including a date and a time at which the peculiar event actually occurs and the weather data at the time of occurrence to the energy operation management apparatus 4A. In the present specification, information regarding occurrence of the peculiar event is distinguished from the weather data and referred to as the peculiar event information.

### Energy Market 3

The energy market 3 proposes an energy price per unit amount in a certain date and time to the energy operation management apparatus 4A. In response to an energy purchase request from the energy operation management apparatus 4A, the energy market 3 supplies the energy to each apparatus 50 of the energy supply system 5 via the infrastructure facility 200.

### Energy Operation Management Apparatus 4A

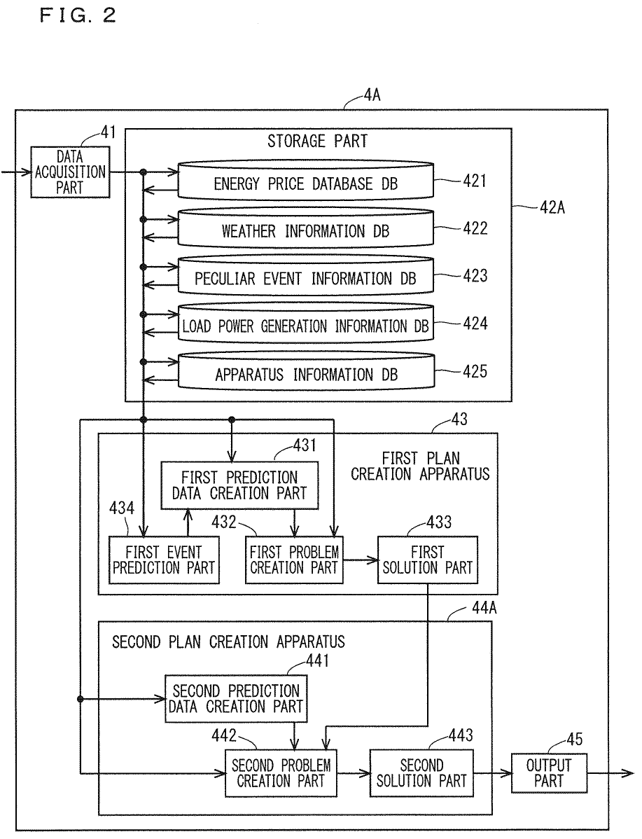

FIG. 2 is a block diagram schematically illustrating a configuration of the energy operation management apparatus 4A. As illustrated in FIG. 2, the energy operation management apparatus 4A includes a data acquisition part 41, a storage part 42A, a first plan creation apparatus 43, a second plan creation apparatus 44A, and an output part 45.

The first plan creation apparatus 43 includes a first prediction data creation part 431, a first problem creation part 432, a first solution part 433, and a first event prediction part 434.

The second plan creation apparatus 44A includes a second prediction data creation part 441, a second problem creation part 442, and a second solution part 443.

### Data Acquisition Part 41

The data acquisition part 41 acquires data T1 from the weather management system 2. The data T1 includes the weather data (the actual value and the predicted value) and the peculiar event information. The data acquisition part 41 acquires data T2 of the energy price from the energy market 3, and acquires data T4 of each apparatus 50 from the energy supply system 5. The data acquisition part 41 acquires data T6 of an actual value of a power generation amount at each time from the renewable energy facility 6, and acquires data T7 of an actual value of a demand (electrical power or heat, for example) at each time from each consumer 70. A frequency of acquiring the data is every day, every several hours, or every several minutes, for example.

The data T4 of each apparatus 50 may include data indicating characteristics such as a capacity, input-output upper and lower limit values, a coefficient relating to input-output characteristics, or an input-output energy type of each apparatus 50, for example. The data T4 may include a value actually outputted from each apparatus 50 in accordance with an instruction T5 from the energy operation management apparatus 4A. The data T4 may include data expressing how each apparatus 50 is connected. The data T4 is stored in each apparatus.

### Storage Part 42A

The storage part 42A includes an energy price database (DB) 421, weather information DB 422, peculiar event information DB 423, load power generation information DB 424, and apparatus information DB 425, and data acquired by the data acquisition part 41 is stored in these data bases. The data acquired by the data acquisition part 41 and stored in the storage part 42A is also referred to as storage data.

The energy price DB 421 stores the data T2 of the energy price acquired from the energy market 3 by the data acquisition part 41. The weather data in the data T1 acquired from the weather management system 2 by the data acquisition part 41 is stored in the weather information DB 422, and the peculiar event information is stored in the peculiar event information DB 423. The load power generation information DB 424 stores the data T6 of the actual value of the power generation amount acquired from the renewable energy facility 6 by the data acquisition part 41 and the data T7 of the actual value of the demand acquired from the consumer group 7 by the data acquisition part 41. The apparatus information DB 425 stores the data T4 acquired from each apparatus 50 of the energy supply system 5 by the data acquisition part 41.

### First Plan Creation Apparatus 43

The first plan creation apparatus 43 creates the energy operation plan in the first period. The energy operation plan in the first period is also referred to as the first operation plan. The energy operation plan determines when, how much, and which type of energy is bought from the energy market 3 by the energy supply system 5 and when, how much, and which type of energy is created by each apparatus 50.

The first period as a period during which the first plan creation apparatus 43 creates the energy operation plan is longer than the second period as a period during which the second plan creation apparatus 44A described hereinafter creates the energy operation plan. For example, the first period is several weeks or several months. The first plan creation apparatus 43 includes the first prediction data creation part 431, the first problem creation part 432, the first solution part 433, and the first event prediction part 434.

### First Event Prediction Part 434

The first event prediction part 434 predicts whether the peculiar event occurs in the first period. This prediction is performed using the peculiar event information stored in the peculiar event information DB 423, for example. Alternatively, this prediction is performed using the data stored in the peculiar event information DB 423, the weather information DB 422, and the load power generation information DB 424. The first event prediction part 434 can predict occurrence of the peculiar event by machine learning using elements such as a month, a time, or a temperature closely relating to the peculiar event to be predicted as a feature amount, for example. However, a method of extracting the feature amount is not limited thereto. The first event prediction part 434 may predict occurrence of the peculiar event using statistics. The prediction method in the first event prediction part 434 is not limited thereto.

The first event prediction part 434 may predict a probability or a risk with which the peculiar event occurs in the first period. The probability of occurrence of the peculiar event may be data included in the peculiar event information acquired from the weather management system 2, or may also be calculated by the first event prediction part 434.

The first event prediction part 434 outputs the prediction result relating to occurrence of the peculiar event in the first period as the first event prediction data to the first prediction data creation part 431.

### First Prediction Data Creation Part 431

The first prediction data creation part 431 predicts the output of the renewable energy facility 6, the consumption energy of the consumer group 7, and the energy price in the energy market 3 for each time in the first period based on the data stored in the storage part 42A and the first event prediction data outputted from the first event prediction part 434. The prediction data of the output of the renewable energy facility 6, the consumption energy of each consumer, and the energy price in the energy market 3 for each time in the first period is also referred to as “the first prediction data”.

The first prediction data creation part 431 predicts the output of the renewable energy facility 6 and the demand of the consumer 70 using the weather data stored in the weather information DB 422 and the data T6 of the output actual value of the renewable energy facility 6 and the data T7 of the demand actual value of the consumer group 7 stored in the load power generation information DB 424. For example, the first prediction data creation part 431 can predict the output of the renewable energy facility 6 and the consumption energy of the consumer 70 by machine learning using the elements (a type of a month and a day, a time, or a temperature, for example) closely relating to the peculiar event to be predicted as the feature amount. When the first prediction data creation part 431 acquires an occurrence probability of the peculiar event in the first period as the first event prediction data from the first event prediction part 434, the first prediction data creation part 431 creates the first prediction data also in consideration of the probability of occurrence of the peculiar event. However, the method of extracting the feature amount is not limited thereto.

There is a high possibility that the energy price in the energy market 3 relates to the output of the renewable energy facility 6 and the demand of each consumer 70. There is a high possibility that the energy price in the energy market 3 is also influenced by occurrence of the peculiar event. Thus, the first prediction data creation part 431 may predict the energy price in the energy market 3 in the first period by statistics or machine learning, for example, based on the data stored in the energy price DB 421, the weather information DB 422, and the load power generation information DB 424 and the first event prediction data outputted from the first event prediction part 434.

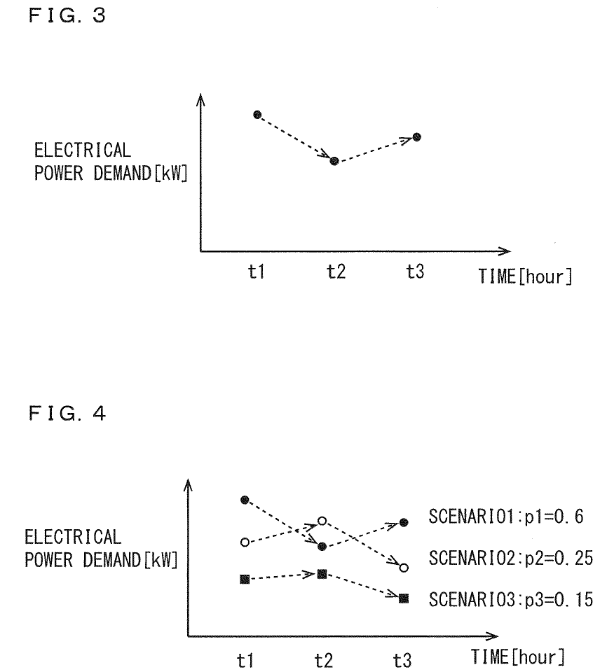

FIG. 3 illustrates an electrical power demand [kW] of the consumer group 7 in the first period as an example of the first prediction data. A lateral axis in FIG. 3 expresses a time in the first period. In FIG. 3, one piece of the prediction data of the electrical power demand is created for each of times t1, t2, and t3. That is to say, the prediction data of the electrical power demand is created for a single scenario herein. The prediction data of output of the renewable energy facility 6 or the prediction data of the energy price in the energy market 3 may also be created for a single scenario in the similar manner.

FIG. 4 illustrates a case of creating the electrical power demand [kW] of the consumer group 7 in the first period as the example of the first prediction data based on an assumption of a plurality of scenarios. In FIG. 4, three pieces of the electrical power demand prediction data are created for each of the times t1, t2, and t3 in the first period. That is to say, the prediction data of the electrical power demand is created for three scenarios of scenarios 1, 2, and 3 herein. The prediction data of output of the renewable energy facility 6 or the prediction data of the energy price in the energy market 3 may also be created for a plurality of scenarios in the similar manner. In this manner, since the plural pieces of the first prediction data is created based on the assumption of the plurality of scenarios, the energy operation plan can be created in consideration of uncertainty of the demand or the energy price, for example.

When the first prediction data creation part 431 creates the plural pieces of the first prediction data based on the assumption of the plurality of scenarios, each scenario has a probability of occurrence. Herein, when the number of scenarios is N and the probability of occurrence of j^{th} scenario is pj, the first prediction data creation part 431 obtains a probability distribution of an uncertainty element so that p1+p2 +. . . +pN=1 is satisfied. For example, in FIG. 4, N=3 is satisfied, a probability of occurrence p1 of the scenario 1 is 0.6, a probability of occurrence p2 of the scenario 2 is 0.25, and a probability of occurrence p3 of the scenario 3 is 0.15. The probability distribution of the uncertainty element at each time t in the first period is obtained based on the statistical prediction, but may be obtained using a method other than statistics. In this manner, the first prediction data creation part 431 may create the plural pieces of the first prediction data having a different probability of occurrence for each time in the first period.

FIGS. 3 and 4 express the prediction data of the electrical power demand of the consumer group 7. In the manner similar thereto, when the prediction data of output of the renewable energy facility 6 is expressed by the diagram, a unit of a vertical axis is also [kW]. When the prediction data of an electrical power price per unit amount is expressed by the diagram in the similar manner, a unit of a vertical axis is [yen/kWh]. When the prediction data of a heat demand of the consumer 70 is expressed by the diagram in the similar manner, a unit of a vertical axis is [m³]. When the prediction data of a heat amount price per unit amount, that is to say, a heat unit price is expressed by the diagram in the similar manner, a unit of a vertical axis is [yen/m³]. A temporal interval of t1, t2, and t3 in FIGS. 3 and 4, that is to say, a temporal granularity of the first prediction data created by the first prediction data creation part 431 may be several hours or several minutes, thus is not limited thereto.

### First Problem Creation Part 432 and First Solution Part 433

The first problem creation part 432 creates an optimization problem (also referred to as “a first optimization problem” hereinafter) for creating the energy operation plan in the first period based on the first prediction data created by the first prediction data creation part 431 and the data T4 of each apparatus 50 stored in the apparatus information DB 425.

The first solution part 433 solves the first optimization problem created by the first problem creation part 432 and creates the energy operation plan in the first period. The first solution part 433 may solve the first optimization problem by a mathematical programming method or a heuristic method, or may also solve the first optimization problem by the other method.

An objective function of the first optimization problem is described herein. An object of the first problem creation part 432 is to minimize a total sum of an electrical power purchase-sale cost and a gas purchase cost in the first period in the energy supply system 5 while a plurality of limitation conditions are satisfied. Expression (1) indicates an example of an objective function created for the first prediction data of a single scenario.

[Expression 1]

Σₜ[ebuy(t)×Ebuy(t)−esale(t)×Esale(t)+gbuy(t)×Gbuy(t)] (1)

In Expression (1), t expresses a time, e buy (t) expresses an electrical power purchase unit price, E buy (t) expresses an electrical power purchase amount, e sale (t) expresses an electrical power sale unit price, E sale (t) expresses an electrical power sale amount, g buy (t) expresses a gas purchase unit price, and G buy (t) expresses a gas purchase amount. All of e buy (t), E buy (t), e sale (t), E sale (t), g buy (t), and G buy (t) indicate positive values.

Although one type of electrical power and one type of gas are to be bought and sold herein to simplify the description, plural types thereof may be bought and sold. When there are two types of electrical power to be bought, for example, e buy (t)×E buy (t) in Expression (1) is e1 buy (t)×E1 buy (t)+e2 buy (t)×E2 buy (t).

When Expression (1) is minimized, the first solution part 433 can create a purchase plan and sale plan of the energy to maximize a profit. Although only the electrical power and the gas are taken into consideration as the energy to be bought and sold in Expression (1), the other fuel such as coal or oil may also be taken into consideration.

The first problem creation part 432 sets the following Expression (2) to Expression (12) for the first prediction data of the single scenario as limitation conditions of the first optimization problem. The i^{th} apparatus 50 is also referred to as the apparatus i in the description of these Expressions.

[Expression 2]

Vi_in_min·ui(t)≤Vi_in(t)≤Vi_in_max·ui(t) (2)

Expression (2) indicates an input upper and lower limits of the apparatus 50. Vi_in (t) indicates input of the apparatus i at the time t, Vi_in_min indicates a minimum input of the apparatus i, and Vi_in_max indicates a maximum input of the apparatus i.

[Expression 3]

Vi_out_min·ui(t)≤Vi_out(t)≤Vi_out_max·ui(t) (3)

Expression (3) indicates an output upper and lower limits of the apparatus 50. Vi_out (t) indicates output of the apparatus i at the time t, Vi_out_min indicates a minimum output of the apparatus i, and Vi_out_max indicates a maximum output of the apparatus i. In Expression (2) and Expression (3), a variable ui (t) expresses a state of the apparatus i stopping activation at the time t. When the apparatus i is in a stopping state, the variable ui (t) is 0, and when the apparatus i is in an activation state, the variable ui (t) is 1.

[Expression 4]

Vi_rate_min·ui(t)≤Vi_out(t)−Vi_out(t−1)≤Vi_rate_max·ui(t) (4)

Expression (4) indicates a limitation of an output variation range of each apparatus 50 from a time t−1 to the time t. Vi_rate_min indicates a lower limit value of the output variation range of the apparatus i from the time t−1 to the time t, and Vi_rate_max indicates an upper limit value of the output variation range of the apparatus i from the time t−1 to the time t.

Expressions (2), (3), and (4) are general-purpose models which can be used for the apparatus i with no activation and stopping of an energy storage apparatus, for example, when the variable ui (t) is set to a constant 1. Although in Expressions (2), (3), and (4), V is indicated as an input-output value of versatile energy, when V is replaced with P (electrical power), G (gas), or H (heat), a limitation conforming to each apparatus 50 can be described. The heat may be finely classified into warm water, cool water, or steam, for example. The plurality of input upper and lower limitations are set to the apparatus 50 having a plurality of inputs. The plurality of output upper and lower limitations are set to the apparatus 50 having a plurality of outputs.

[Expression 5]

SOCi_min≤SOCi(t)≤SOCi_max (5)

Expression (5) indicates an upper and lower limitation of an energy storage amount relating to a storable capacity of the energy storage apparatus. The apparatus 50 as an i^{th} energy storage apparatus is also referred to as the energy storage apparatus i in the description of the Expressions. SOCi_min indicates a minimum value of the energy storage amount of the energy storage apparatus i, and SOCi_max indicates a maximum value of the energy storage amount of the energy storage apparatus i. SOCi (t) indicates the energy storage amount of the energy storage apparatus i at the time t.

[Expression 6]

SOC_first=SOC(t_first) (6)

Expression (6) indicates an initial value limitation of the energy storage amount relating to the storable capacity of the energy storage apparatus. An energy storage amount SOC (t_first) of the energy storage apparatus i at a start time t=t_first of the first period is determined as SOC_first.

[Expression 7]

SOC_last≤SOC(t_last) (7)

Expression (7) indicates a final value limitation of the energy storage amount relating to the storable capacity of the energy storage apparatus. The energy storage amount SOC (t_last) of the energy storage apparatus i at a final time t=t last of the first period is equal to or larger than SOC_last. That is to say, SOC_last indicates a minimum energy storage amount of the energy storage apparatus i at the final time t=t_last of the first period.

[Expression 8]

SOC(t+1)=SOC(t)+(a·Vi_in(t)−Vi_out(t)−b)·Δt (8)

Expression (8) indicates an equation for calculating the storage amount of the energy storage apparatus. a indicates a charge efficiency, b indicates a natural electrical discharge amount or a natural heat radiation amount, and Δt indicates a time interval from the time t to the time t+1.

[Expression 9]

Ebuy(t)−Esale(t)=ΣᵢPi_in(t) (9)

Expression (9) indicates a limitation relating to an electricity purchase-sale amount at each time in the first period. Pi_in (t) indicates the electrical power inputted to the apparatus i at the time t.

[Expression 10]

Gbuy(t)=ΣᵢGi_in(t) (10)

Expression (10) indicates a limitation relating to the gas purchase amount. Gi_in (t) indicates a gas amount inputted to the apparatus i at the time t.

[Expression 11]

ΣᵢPi_out(t)=Pdem(t) (11)

Expression (11) indicates a demand-supply balance limitation of the electrical power at each time in the first period. Pdem (t) indicates a predicted value of the electrical power demand in the consumer group 7.

[Expression 12]

ΣᵢHi_out(t)=Hdem(t) (12)

Expression (12) indicates a demand-supply balance limitation of the heat at each time in the first period. Hdem (t) indicates a predicted value of the heat demand in the consumer group 7.

The first solution part 433 solves the optimization problem of minimizing Expression (1) under the limitation condition from Expression (2) to Expression (12) based on the first predication data created by the first prediction data creation part 431, thereby being able to create the energy operation plan in the first period to maximize the profit.

Herein, an activation cost of each apparatus i may be added as a positive term to Expression (1). A limitation condition of a minimum drive time or a minimum stop time may be added to Expression (2) to Expression (12) for the apparatus having an activation and stopping operation. The minimum drive time is a time in which the apparatus should be continuously driven after activating the apparatus. The minimum stop time is a time in which the apparatus should be continuously stopped after stopping the apparatus. An upper limit value may be imposed on the number of activation and stopping of each apparatus in a calculation target time. A limitation condition that only one of input and output can be performed at the time t may be provided to the energy storage apparatus. A time delay of output with regard to input of each apparatus may be provided as a limitation condition regardless of presence or absence of the activation and stopping state.

The above has described the creation of the energy operation plan in the first period based on the first prediction data of the single scenario. Next, the following Expression (13) indicates an example of an objective function created by the first problem creation part 432 for the first prediction data of the plurality of scenarios.

[Expression 13]

ΣₜΣⱼpj·[ejbuy(t)×Ejbuy(t)−ejsale(t)×Ejsale(t)+gjbuy(t)×Gjbuy(t)] (13)

Herein, the first prediction data creation part 431 creates N scenarios. A probability of occurrence of the j^{th} scenario is expressed as pj. In Expression (13), in a scenario j at the time t, ej buy (t) expresses an electrical power purchase unit price, Ej buy (t) expresses an electrical power purchase amount, ej sale (t) expresses an electrical power sale unit price, Ej sale (t) expresses an electrical power sale amount, gj buy (t) expresses a gas purchase unit price, and Gj buy (t) expresses a gas purchase amount. The first solution part 433 solves the optimization problem of minimizing Expression (13), thereby being able to create the energy operation plan in the first period for maximizing an expected profit, that is to say, minimizing an expected cost in consideration of the plurality of scenarios.

Minimization of a cost worse value, for example, is considered as a method of creating the objective function in consideration of each scenario in addition to the minimization of the expected cost. However, the creation method is not limited thereto.

Described is an example of a limitation expression of the optimization problem in consideration of each scenario. For example, considered is that the activation and stopping state of the apparatus i and the energy storage amount of the energy storage apparatus i at the time t are common in each scenario, and input and output of the apparatus and a purchase amount and a sale amount of the energy are obtained for each scenario. At this time, Expressions (2), (3), (4), (9), (10), (11), and (12) are expressed by Expressions (14), (15), (16), (17), (18), (19), and (20), respectively.

[Expression 14]

Vi_in_min·ui(t)≤Vij_in(t)≤Vi_in_max·ui(t) (14)

[Expression 15]

Vi_out_min·ui(t)≤Vij_out(t)≤Vi_out_max·ui(t) (15)

[Expression 16]

Vi_rate_min·ui(t)≤Vij_out(t)−Vij_out(t−1)≤Vi_rate_max·ui(t) (16)

[Expression 17]

Ejbuy(t)−Ejsale(t)=ΣᵢPij_in(t) (17)

[Expression 18]

Gjbuy(t)=ΣᵢGij_in(t) (18)

[Expression 19]

ΣᵢPij_out(t)=Pjdem(t) (19)

[Expression 20]

ΣᵢHijₒᵤₜ₍ₜ₎=Hjdem(t) (20)

Vij_in (t) indicates input at the time t in the scenario j in the apparatus i, and Vij_out (t) indicates output at the time t in the scenario j in the apparatus i. Pjdem (t) indicates a demand prediction value of the electrical power at the time t in the scenario j, and Hjdem (t) indicates a demand prediction value of the heat at the time t in the scenario j.

### Second Plan Creation Apparatus 44A

The second plan creation apparatus 44A creates the energy operation plan in the second period. The energy operation plan in the second period is also referred to as the second operation plan. The second period as a period during which the second plan creation apparatus 44A creates the energy operation plan is shorter than the first period as a period during which the first plan creation apparatus 43 creates the energy operation plan. For example, the second period is several days or several weeks. The second plan creation apparatus 44A includes the second prediction data creation part 441, the second problem creation part 442, and the second solution part 443.

### Second Prediction Data Creation Part 441

The second prediction data creation part 441 predicts the output of the renewable energy facility 6, the consumption energy of the consumer group 7, and the energy price in the energy market 3 for each time in the second period based on the data stored in the storage part 42A. The prediction data of the output of the renewable energy facility 6, the consumption energy of each consumer, and the energy price in the energy market 3 for each time in the second period is also referred to as “the second prediction data”.

The second prediction data creation part 441 predicts the output of the renewable energy facility 6 and the demand of the consumer 70 using the weather data stored in the weather information DB 422 and the data T6 of the output actual value of the renewable energy facility 6 and the data T7 of the demand actual value of the consumer group 7 stored in the load power generation information DB 424. For example, the second prediction data creation part 441 can predict the output of the renewable energy facility 6 and the energy consumption of the consumer 70 by machine learning using the elements (a type of a month and a day, a time, or a temperature, for example) closely relating to the prediction target as the feature amount. However, the method of extracting the feature amount is not limited thereto. The second prediction data creation part 441 may create the second prediction data using statistics. A method of creating the second prediction data is not limited to the above method.

There is a high possibility that the energy price in the energy market 3 relates to the output of the renewable energy facility 6 and the demand of each consumer 70. Thus, the second prediction data creation part 441 may predict the energy price in the energy market 3 by statistics or machine learning, for example, based on the data stored in the energy price DB 421, the weather information DB 422, and the load power generation information DB 424.

When the second prediction data creation part 441 creates the second prediction data for each of the output of the renewable energy facility 6, an energy purchase price or sale price in the energy market 3, or the consumption energy amount of the consumer 70, the second prediction data creation part 441 may create a single piece of second prediction data based on the assumption of the single scenario or the plural pieces of the second prediction data based on the assumption of the plurality of scenarios. That is to say, the second prediction data creation part 441 may create the plural pieces of the second prediction data having a different probability of occurrence for each time in the second period.

### Second Problem Creation Part 442 and Second Solution Part 443

The second problem creation part 442 creates an optimization problem (also referred to as “second optimization problem” hereinafter) for creating the energy operation plan in the second period based on the second prediction data created by the second prediction data creation part 441, the data T4 of each apparatus 50 stored in the apparatus information DB 425, and the energy operation plan in the first period created by the first solution part 433.

The second solution part 443 solves the second optimization problem created by the second problem creation part 442 and creates the energy operation plan in the second period. The second solution part 443 may solve the second optimization problem by a mathematical programming method or a heuristic method, or may also solve the second optimization problem by the other method.

An objective function of the second optimization problem is described herein. An object of the second problem creation part 442 is to minimize a total sum of an electrical power purchase-sale cost and a gas purchase cost in the second period in the energy supply system 5 while a plurality of limitation conditions are satisfied. An example of an objective function of the second optimization problem created for the second prediction data of the single scenario is expressed by Expression (1) in the manner similar to the objective function of the first optimization problem. A limitation condition of the second optimization problem is expressed by Expression (2) to Expression (21).

The activation cost of each apparatus i may be added as a positive term to Expression (1). The limitation condition of the minimum drive time or the minimum stop time may be added to Expression (2) to Expression (12) for the apparatus having the activation and stopping operation. The upper limit value may be provided to the number of activation and stopping of each apparatus in the calculation target time. The limitation condition that only one of input and output can be performed at the time t may be provided to the energy storage apparatus. The time delay of output with regard to input of each apparatus may be provided as the limitation condition regardless of presence or absence of the activation and stopping state.

Furthermore, a limitation condition regarding the energy operation plan in the first period created by the first solution part 433 is provided to the second optimization problem. For example, the energy storage amount of the energy storage apparatus i at the time t in the first period may be added as the limitation condition. This limitation condition is expressed by Expression (21).

[Expression 21]

SOCi1(t)×(1−c)≤SOCi2(t)≤SOCi1(t)×(1+c) (21)

In Expression (21), SOCi1 (t) indicates the energy storage amount of the energy storage apparatus i at the time t in the first period determined by the first solution part 433. SOCi2 (t) indicates the energy storage amount of the energy storage apparatus i at the time t in the second period. c is a constant equal to or larger than 0 and equal to or smaller than 1. The second solution part 443 minimizes Expression (1) using Expression (21) as the limitation condition, thereby being able to create the operation plan of the energy storage amount of the energy storage apparatus i in the second period to follow the operation plan of the energy storage amount of the energy storage apparatus i in the first period as much as possible. In this manner, the energy operation plan in the second period is created based on the energy operation plan in the first period determined in consideration of the maximization of the expected profit.

However, the energy operation plan in the first period considered as the limitation condition of the energy operation plan in the second period is not limited thereto described above. When the second prediction data creation part 441 creates the second prediction data based on the assumption of the plurality of scenarios, the second problem creation part 442 may create the optimization problem in consideration of each scenario.

### Output Part 45

The output part 45 buys the energy from the energy market 3 based on the energy operation plan in the second period determined by the second solution part 443, and transmits instruction to each apparatus 50 in the energy supply system 5. Each apparatus 50 supplies the energy to the consumer group 7 in accordance with the instruction received from the output part 45.

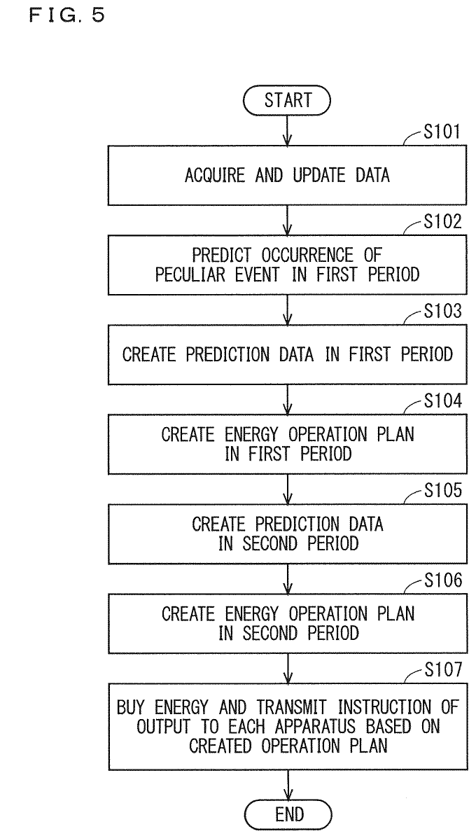

FIG. 5 is a flow chart illustrating an example of a procedure of a method of creating the energy operation plan performed by the energy operation management apparatus 4A. An operation of the energy operation management apparatus 4A is described hereinafter along the flow in FIG. 5.

Firstly, the data acquisition part 41 acquires various types of data and updates data stored in the storage part 42A (Step S101). Specifically, the data acquisition part 41 acquires the data T1 including the weather data and the peculiar event information from the weather management system 2, acquires the data T2 of the energy price from the energy market 3, acquires the data T4 regarding each apparatus 50 from the energy supply system 5, acquires the data T6 of the actual value of the power generation amount at each time from the renewable energy facility 6, and acquires the data T7 of the actual value of the demand at each time from each consumer 70.

Next, the first event prediction part 434 predicts whether the peculiar event occurs in the first period using the weather information stored in the weather information DB 422 and the peculiar event information stored in the peculiar event information DB 423 (Step S102).

Subsequently, the first prediction data creation part 431 creates the prediction data of the output of the renewable energy facility 6, the consumption energy of the consumer group 7, and the energy price in the energy market 3 in the first period as the first prediction data based on the data stored in the storage part 42 and the prediction result of the first event prediction part 434 (Step S103).

Next, the first problem creation part 432 creates the optimization problem of the energy operation plan in the first period using the data stored in the apparatus information DB 425 and the first prediction data. Then, the first solution part 433 solves the optimization problem and creates the energy operation plan in the first period (Step S104).

It is also applicable that the energy operation management apparatus 4A performs Step S101 to Step S104 described above in a period shorter than the first period such as every several months or every several weeks, for example, and updates the energy operation plan in the first period as needed. That is to say, the first event prediction part 434 updates the first event prediction data with a cycle shorter than the first period, the first prediction data creation part 431 updates the first prediction data based on the updated first event prediction data and the storage data, the first problem creation part 432 updates the first optimization problem based on the storage data and the updated first prediction data, and the first solution part 433 acquires the solution of the update first optimization problem, thereby updating the first operation plan.

Next, the second prediction data creation part 441 creates the prediction data of the output of the renewable energy facility 6, the consumption energy of the consumer group 7, and the energy price in the energy market 3 in the second period as the second prediction data using the data stored in the storage part 42A (Step S105).

Subsequently, the second problem creation part 442 creates the optimization problem of the energy operation plan in the second period based on the data stored in the apparatus information DB 425, the second prediction data, and the energy operation plan in the first period created by the first solution part 433. The second solution part 443 solves the optimization problem of the energy operation plan in the second period and creates the energy operation plan in the second period (Step S106).

The energy operation management apparatus 4A may perform Step S105 and Step S106 in a period shorter than the second period such as every several weeks or several days, for example, and correct the energy operation plan in the second period as needed. That is to say, the second prediction data creation part 441 updates the second prediction data with a cycle shorter than the second period, the second problem creation part 442 updates the second optimization problem based on the storage data and the updated second prediction data, and the second solution part 443 solves the updated second optimization problem, thereby updating the second operation plan.

Finally, the output part 45 buys the energy from the energy market 3 in accordance with the energy operation plan in the second period created by the second solution part 443, and transmits instruction of output to each apparatus 50 in the energy supply system 5 (Step S107). The processing of the energy operation management apparatus 4A is thereby finished.

### Energy Supply System 5

There are various types of the apparatuses 50 constituting the energy supply system 5. Various patterns are assumed as the energy supply system 5 depending on a way of connecting the apparatus 50. An example of the energy supply system 5 is described hereinafter.

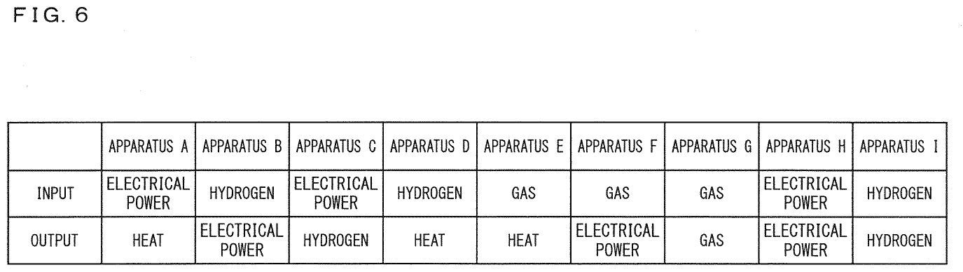

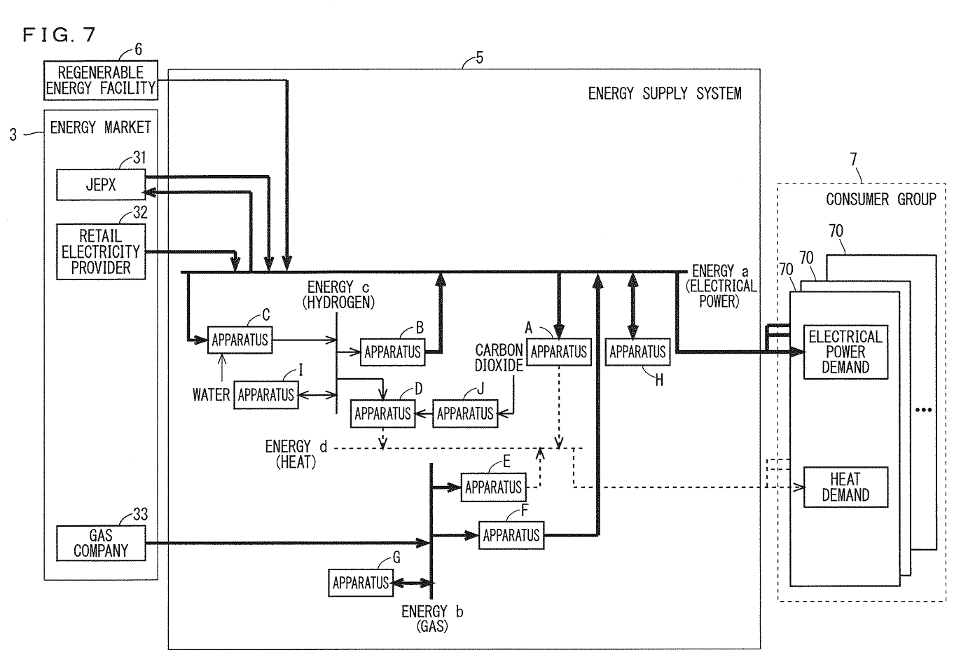

FIG. 6 indicates energy type information of input and output of an apparatus A to an apparatus H as the apparatuses 50 in the data T4 regarding the apparatus 50. FIG. 7 is a diagram illustrating a connection relationship of the apparatus A to the apparatus H. In FIG. 7, the energy market 3 includes a Japan electric power exchange (JEPX) 31, a retail electricity provider 32, and a gas company 33. The energy supply system 5 receives energy a, that is to say, electrical power from the JEPX 31, the retail electricity provider 32, and the renewable energy facility 6, and sells the electrical power to the JEPX 31. The energy supply system 5 buys energy b, that is to say, gas from the gas company 33.

The apparatus A to the apparatus H supply electrical power and heat to each consumer 70 based on the instruction of the energy operation management apparatus 4A, and sells the electrical power to the JEPX 31. Specifically, the apparatus A generates energy d, that is to say, heat using the electrical power. The apparatus B generates electrical power using energy c, that is to say, hydrogen. The apparatus C generates hydrogen using electrical power and water. The apparatus D generates heat using hydrogen and carbon dioxide. In FIG. 7, carbon dioxide is collected from air and stored in the apparatus J, and is inputted to the apparatus D. Carbon dioxide discharged from a biomass power station or a plant is considered to be collected as a method of collecting carbon dioxide.

The apparatus E generates heat using gas. The apparatus F generates electrical power using gas. The apparatus G is a tank which can store gas. The apparatus H is a storage cell, and the apparatus I is a tank which can store hydrogen. The energy d is heat, but may be finely classified into warm water, cool water, or steam. The heat demand of the consumer 70 may also be finely classified into warm water, cool water, or steam. The consumer 70 is a general household, a plant, a building, or a public facility, for example, but is not limited thereto. Each of the apparatus A to the apparatus J may be made up of a plurality of apparatuses. In this manner, in the energy supply system 5 illustrated in FIG. 7, the apparatus A to the apparatus J are mutually connected via energy.

The energy operation management apparatus 4A according to the embodiment 1 creates the operation plan of the plurality of apparatuses 50 supplying the energy to the consumer group 7 using the generated electrical power in the renewable energy facility 6 and the energy bought from energy market 3. The energy operation management apparatus 4A includes the data acquisition part 41, the first event prediction part 434, the first prediction data creation part 431, the first problem creation part 432, the first solution part 433, the second prediction data creation part 441, the second problem creation part 442, and the output part 45.

The data acquisition part 41 acquires the storage data including the actual value of the energy price in an energy market 3, the energy demand of the consumer group 7, the generated electrical power of the renewable energy facility 6, and the weather data, and makes the storage part 42A store the storage data. The first event prediction part 434 predicts whether the peculiar event as the phenomenon having influence on at least any one of the energy price, the energy demand, and the generated electrical power occurs in the first period based on the storage data. The first prediction data creation part 431 predicts at least any one of the energy price, the energy demand, and the generated electrical power in the first period based on the storage data and first event prediction data as the prediction result of the first event prediction part 434.

The first problem creation part 432 creates the first optimization problem for determining the first operation plan as the operation plan of the plurality of apparatuses 50 in the first period based on the storage data and first prediction data as the prediction result of the first prediction data creation part 431. The first solution part 433 acquires the solution of the first optimization problem, thereby determining the first operation plan.

The second prediction data creation part 441 predicts at least any one of the energy price, the energy demand, and the generated electrical power in the second period shorter than the first period based on the storage data. The second problem creation part 442 creates the second optimization problem for determining the second operation plan as the operation plan of the plurality of apparatuses 50 in the second period based on the storage data, the second prediction data as the prediction result of the second prediction data creation part 441, and the first operation plan. The second solution part 443 acquires the solution of the second optimization problem, thereby determining the second operation plan.

The output part 45 performs the energy purchase request to the energy market 3 based on the second operation plan and transmits instruction of the operation to the plurality of apparatuses 50.

According to the above configuration, the energy operation management apparatus 4A can create the energy operation plan of each apparatus 50 in consideration of the peculiar event having significant influence on the energy demand, the renewable energy output, or the energy price.

### B. Embodiment 2

A configuration of an energy operation management system 1002 according to an embodiment 2 is as illustrated in FIG. 1. The energy operation management system 1002 includes an energy operation management apparatus 4B in place of the energy operation management apparatus 4A when compared with the configuration of the energy operation management system 1001 according to the embodiment 1. Since the configuration of the energy operation management system 1002 other than the energy operation management apparatus 4B is similar to that of the energy operation management system 1001, the description thereof is omitted.

The energy operation management apparatus 4A according to the embodiment 1 creates the energy operation plan in consideration of the peculiar event only in the first period. However, there is a possibility that a peculiar event such as typhoon or local concentrated heavy rain occurs also in the second period. There is a possibility that the energy amount consumed by the consumer 70, the output of the renewable energy facility 6, and the energy price of the energy market 3 are changed by the peculiar event occurring in the second period. Thus, the energy operation management apparatus 4B according to the embodiment 2 creates the energy operation plan also in consideration of the peculiar event which may occur in the second period.

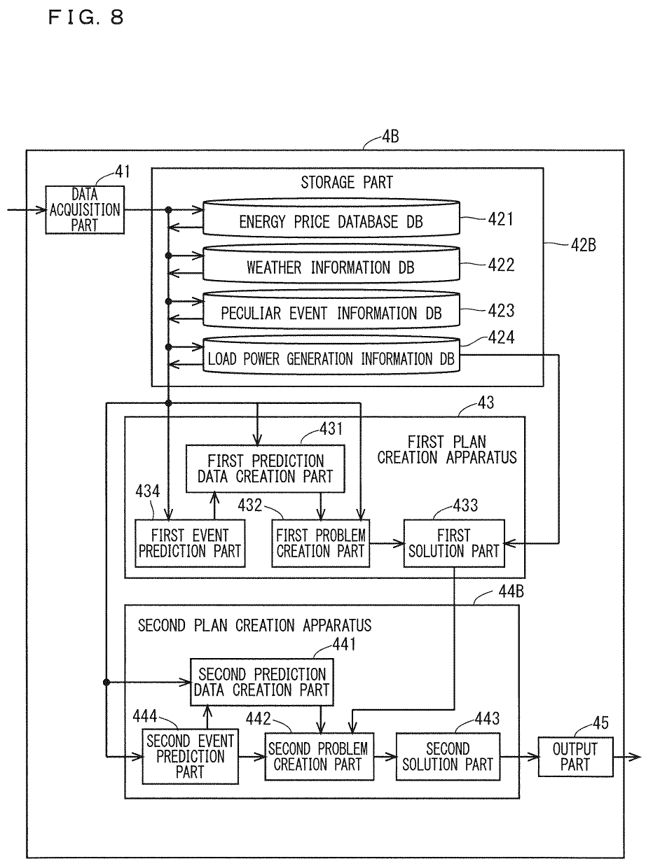

FIG. 8 is a block diagram illustrating the configuration of the energy operation management apparatus 4B according to the embodiment 2. The energy operation management apparatus 4B includes a second plan creation apparatus 44B in place of the second plan creation apparatus 44A when compared with the configuration of the energy operation management apparatus 4A according to the embodiment 1.

The second plan creation apparatus 44B includes a second event prediction part 444 in addition to the configuration of the second plan creation apparatus 44A according to the embodiment 1.

### Second Event Prediction Part 444

The second event prediction part 444 predicts whether the peculiar event occurs in the second period based on peculiar event information acquired from the weather management system 2, past peculiar event information stored in the peculiar event information DB 423, and data stored in the weather information DB 422 and the load power generation information DB 424. The second event prediction part 444 can predict occurrence of the peculiar event by machine learning using elements such as a month, a time, or a temperature closely relating to the peculiar event to be predicted as a feature amount, for example. However, a method of extracting the feature amount is not limited thereto. The second event prediction part 444 may predict occurrence of the peculiar event using statistics. The prediction method in the second event prediction part 444 is not limited thereto.

The second event prediction part 444 may calculate a probability or a risk with which the peculiar event occurs in the second period. The probability of occurrence of the peculiar event may be data included in the peculiar event information acquired from the weather management system 2, or may also be calculated by the second event prediction part 444.

### Second Prediction Data Creation Part 441

The second prediction data creation part 441 according to the embodiment 2 predicts the output of the renewable energy facility 6, the consumption energy of the consumer group 7, and the energy price in the energy market 3 for each time in the second period based on the data stored in the storage part 42B and the prediction result of the second event prediction part 444.

When the second prediction data creation part 441 creates the second prediction data for each of the output of the renewable energy facility 6, the energy purchase price or sale price in the energy market 3, or the consumption energy amount of the consumer 70, the second prediction data creation part 441 may create the single piece of second prediction data based on the assumption of the single scenario or the plural pieces of the second prediction data based on the assumption of the plurality of scenarios.

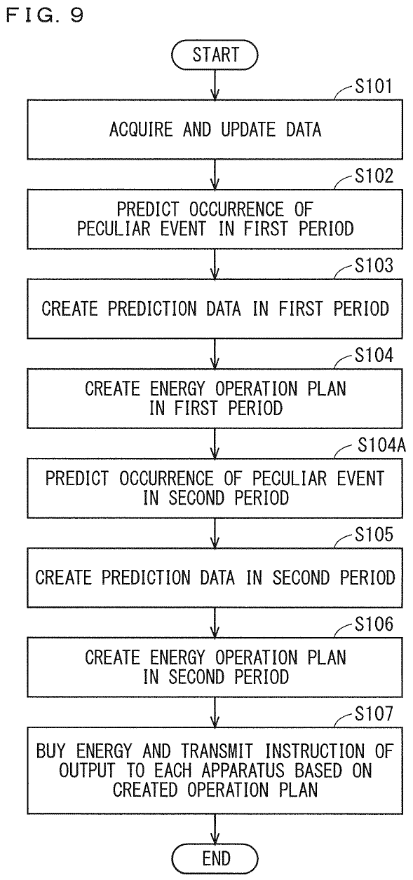

FIG. 9 is a flow chart illustrating an example of a procedure of a method of creating the energy operation plan performed by the energy operation management apparatus 4B. The flow in FIG. 9 is the same as that in FIG. 4 described in the embodiment 1 except that Step S104A is added between Step S104 and Step S105.

In Step S104A, the second event prediction part 444 predicts whether the peculiar event occurs in the second period using the information stored in the weather information DB 422 and the peculiar event information DB 423.

Subsequently, the second prediction data creation part 441 creates the prediction data of the output of the renewable energy facility 6, the consumption energy of the consumer group 7, and the energy price in the energy market 3 in the second period as the second prediction data using the data stored in the storage part 42 and the prediction result of the second event prediction part 444 (Step S105).

The energy operation management apparatus 4B may perform Step 104A, Step S105, and Step S106 in FIG. 9 in a period shorter than the second period such as every several weeks or several days, for example, and correct the energy operation plan in the second period as needed.

The energy operation management apparatus 4B according to the embodiment 2 includes the second event prediction part 444 predicting whether the peculiar event occurs in the second period based on the storage data. The second prediction data creation part 441 creates the second prediction data based on the storage data and the second event prediction data as the prediction result of the second event prediction part. According to the energy operation management apparatus 4B, the energy operation plan can be created in consideration of the peculiar event which may occur in the second period.

### C. Embodiment 3

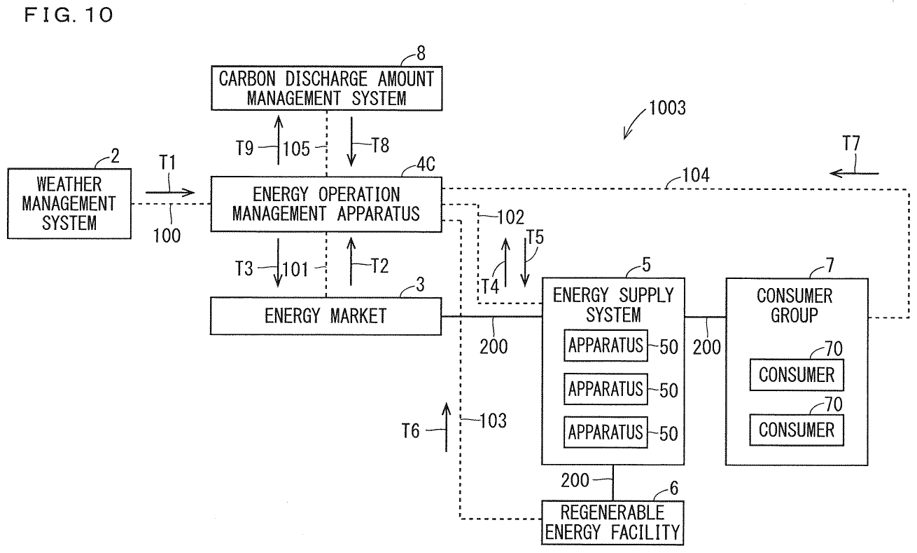

FIG. 10 is a configuration diagram of an energy operation management system 1003 according to an embodiment 3. In the energy operation management systems 1001 and 1002 according to the embodiments 1 and 2, a discharge amount of greenhouse gas such as carbon dioxide (CO2) is not considered in creating the energy operation plan. The energy operation management system 1003 creates the energy operation plan in consideration of a CO2 discharge amount in addition to the peculiar event which may occur in the first period and the second period.

The energy operation management system 1003 includes the weather management system 2, the energy market 3, an energy operation management apparatus 4C, the energy supply system 5, the renewable energy facility 6, the consumer group 7, and a carbon discharge amount management system 8.

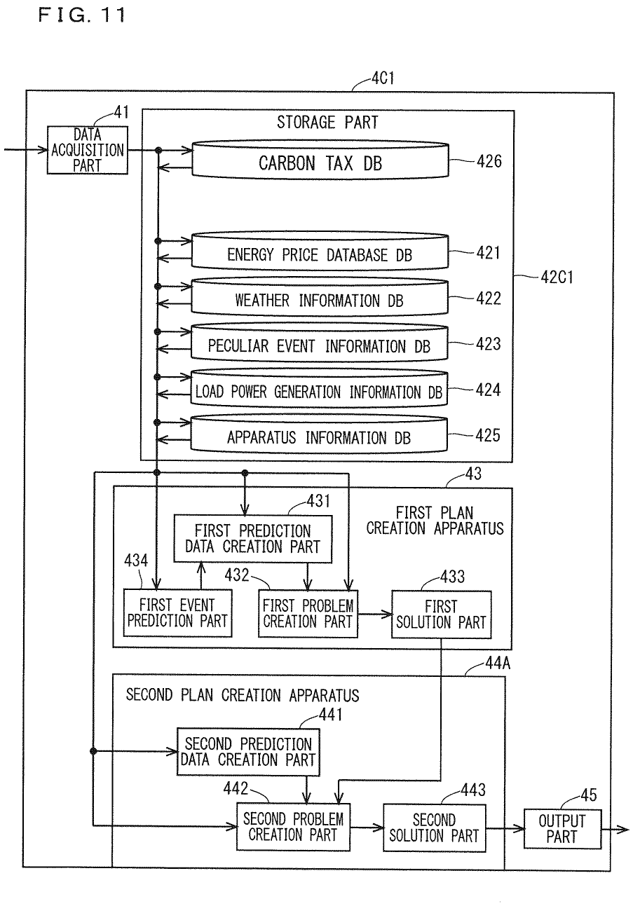

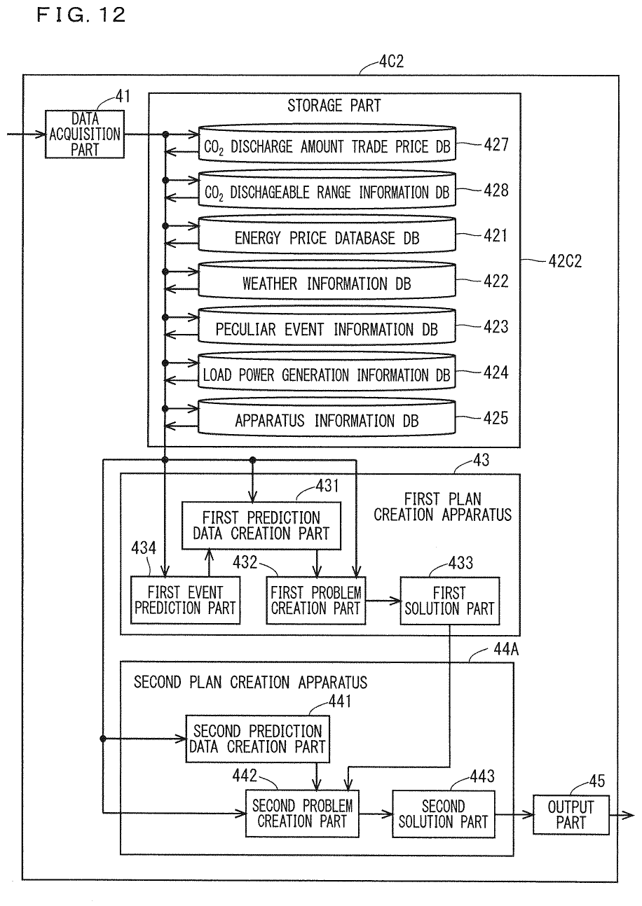

A configuration of the energy operation management apparatus 4C has two patterns of an energy operation management apparatus 4C1 illustrated in FIG. 11 and an energy operation management apparatus 4C2 illustrated in FIG. 12.

The energy operation management apparatus 4C1 is applied when a carbon tax is introduced. The energy operation management apparatus 4C1 includes a storage part 42C1 in place of the storage part 42A when compared with the energy operation management apparatus 4A according to the embodiment 1. The storage part 42C1 includes a carbon tax DB 426 in addition to each database of the storage part 42A.

The energy operation management apparatus 4C2 is applied when a CO2 cap-and-trade system is introduced. The energy operation management apparatus 4C2 includes a storage part 42C2 in place of the storage part 42A when compared with the energy operation management apparatus 4A according to the embodiment 1. The storage part 42C2 includes a CO2 cap-and-trade price DB 427 in addition to each database of the storage part 42A.

A configuration according to the embodiment 3 different from the embodiments 1 and 2 is mainly described.

Considered in recent years is “carbon tax” or “CO2 cap-and-trade system” as a system of placing a price on discharged carbon toward decarbonized society. The carbon tax is a tax charged to a company or each area in accordance with a CO2 discharge amount. The description hereinafter is based on an assumption that the carbon tax is charged to each area. An amount of the carbon tax per unit CO2 discharge amount is determined as a fixed value by the carbon discharge amount management system 8, and when the amount thereof is changed, notification is transmitted from the carbon discharge amount management system 8 to the energy operation management apparatus 4C in each case.

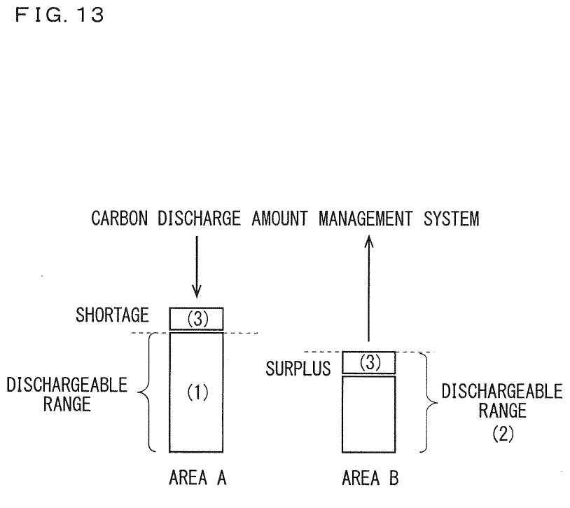

In the meanwhile, in the CO2 cap-and-trade system, an upper limit value of CO2 which can be discharged in a certain period is determined for each area as illustrated in FIG. 13. Since the CO2 discharge amount exceeds an allocated dischargeable range (1) in an area A, the area A additionally buys a CO2 dischargeable range (3) via the carbon discharge amount management system 8. In the meanwhile, since the CO2 discharge amount is smaller than an allocated dischargeable range (2) in an area B, the area B sells a surplus (3) to the carbon discharge amount management system 8, thereby being able to acquire a profit. In the CO2 cap-and-trade system, a CO2 discharge amount trade price is determined by a demand-supply balance of the CO2 discharge amount.

### Carbon Discharge Amount Management System 8

As illustrated in FIG. 10, the carbon discharge amount management system 8 is connected to the energy operation management apparatus 4C via a communication network 105. A case of introducing the carbon tax is described hereinafter.

When the carbon tax is introduced, the energy operation management apparatus 4C1 illustrated in FIG. 11 is applied to the energy operation management apparatus 4C. The carbon discharge amount management system 8 provides the data T8 of the carbon tax charged per unit CO2 discharge amount to the energy operation management apparatus 4C1. The data acquisition part 41 acquires the data T8 of the carbon tax from the carbon discharge amount management system 8, and stores the data T8 in the carbon tax DB 426 in the storage part 42C1.

The data T8 of the carbon tax stored in the carbon tax DB 426 is inputted to the first problem creation part 432 and the second problem creation part 442. Then, the energy operation plan can be created in consideration of the CO2 discharge amount in each of the first period and the second period. For example, the first problem creation part 432 converts a purchase amount of electricity, gas, and a fuel into a CO2 discharge amount in the first period, and adds a term obtained by multiplying a total CO2 discharge amount by a carbon tax per unit CO2 discharge amount to an objective function of Expression (1) as a positive term, thereby being able to make Expression (1) express the optimization problem maximizing the profit in consideration of the carbon tax in accordance with CO2 discharge in the first period.

In the similar manner, the second problem creation part 442 converts a purchase amount of electricity, gas, and a fuel into a CO2 discharge amount in the second period, and adds a term obtained by multiplying a total CO2 discharge amount by a carbon tax per unit CO2 discharge amount to an objective function of Expression (1) as a positive term, thereby being able to make Expression (1) express the optimization problem maximizing the profit in consideration of the carbon tax in accordance with CO2 discharge in the second period.

A procedure of the method of creating the energy operation plan performed by the energy operation management apparatus 4C1 is basically as shown by the flow chart in FIG. 9. However, in Step S104, the first problem creation part 432 and the first solution part 433 create the energy operation plan in the first period also in consideration of the CO2 discharge amount in addition to the peculiar event using the information stored in the carbon tax DB 426. In the similar manner, in Step S106, the second problem creation part 442 and the second solution part 443 create the energy operation plan in the second period also in consideration of the CO2 discharge amount in addition to the peculiar event using the information stored in the carbon tax DB 426.

When the CO2 cap-and-trade system is introduced, the energy operation management apparatus 4C2 illustrated in FIG. 12 is applied to the energy operation management apparatus 4C. The carbon discharge amount management system 8 transmits a CO2 discharge amount trade price and a CO2 dischargeable amount range in a certain period as the data T8 to the energy operation management apparatus 4C2. The CO2 dischargeable amount range may be updated at a constant frequency such as every year, for example.

The data acquisition part 41 of the energy operation management apparatus 4C2 acquires the data T8 of the CO2 discharge amount trade price and the CO2 dischargeable amount range from the carbon discharge amount management system 8, and stores the data of the CO2 discharge amount trade price and the data of the CO2 dischargeable amount range in the CO2 cap-and-trade price DB 427 and the CO2 dischargeable range information DB 428, respectively.

The CO2 discharge amount trade price is determined by the demand-supply balance of the CO2 discharge amount. Thus, the first prediction data creation part 431 and the second prediction data creation part 441 create the prediction data of the CO2 discharge amount trade price in a target period. The first prediction data creation part 431 and the second prediction data creation part 441 may select a feature amount having significant influence on the CO2 discharge amount trade price such as a temperature, a demand, and a power generation amount, for example, using the data stored in the storage part 42C2 and create the prediction data by machine learning. Alternatively, the first prediction data creation part 431 and the second prediction data creation part 441 may create the prediction data using statistics. However, the method of creating the prediction data is not limited thereto.

The prediction data of the CO2 discharge amount trade price in the first period created by the first prediction data creation part 431 is inputted to the first problem creation part 432. Accordingly, the first problem creation part 432 and the first solution part 433 can create the energy operation plan in consideration of the CO2 discharge amount in the first period. The prediction data of the CO2 discharge amount trade price in the second period created by the second prediction data creation part 441 is inputted to the second problem creation part 442. Accordingly, the second problem creation part 442 and the second solution part 443 can create the energy operation plan in consideration of the CO2 discharge amount in the second period.

For example, the first problem creation part 432 and the second problem creation part 442 convert a purchase amount of electricity, gas, or a fuel into the CO2 discharge amount, and have a limitation condition that the CO2 discharge amount is within a CO2 dischargeable range.

An objective function of the second optimization problem includes a term obtained by multiplying a difference between the CO2 discharge amount and the CO2 dischargeable range calculated based on the energy purchase amount in the second period by the CO2 discharge amount trade price in the second period. The energy supply system 5 can acquire an amount obtained by multiplying the difference between the CO2 discharge amount and the CO2 dischargeable range by the CO2 discharge amount trade price per unit amount. Since the first solution part 433 and the second solution part 443 create the energy operation plan so that the CO2 discharge amount is suppressed as much as possible in a period in which the CO2 discharge amount trade price is predicted to be high in the first prediction data creation part 431 and the second prediction data creation part 441, acquisition of a larger profit can be expected.

A procedure of the method of creating the energy operation plan performed by the energy operation management apparatus 4C2 is basically as shown by the flow chart in FIG. 9. However, in Step S103, the first prediction data creation part 431 creates the prediction data of the CO2 discharge amount trade price in the first period in addition to the output of the renewable energy facility 6, the consumption energy of the consumer group 7, and the energy price in the energy market 3. In Step S104, the first problem creation part 432 and the first solution part 433 create the energy operation plan in the first period also in consideration of the CO2 discharge amount in addition to the peculiar event.

In Step S105, the second prediction data creation part 441 creates the prediction data of the CO2 discharge amount trade price in the second period in addition to the output of the renewable energy facility 6, the consumption energy of the consumer group 7, and the energy price in the energy market 3. In Step S106, the second problem creation part 442 and the second solution part 443 create the energy operation plan in the second period also in consideration of the CO2 discharge amount in addition to the peculiar event.

When the carbon tax is introduced, in the energy operation management apparatus 4C1 according to the embodiment 3, the first operation plan includes the energy purchase amount in the energy market at each time in the first period, and the second operation plan includes the energy purchase amount in the energy market at each time in the second period. The storage data includes the data of the carbon tax price per unit CO2 discharge amount. The first problem creation part adds the term obtained by multiplying the CO2 discharge amount calculated based on the energy purchase amount in the first operation plan by the carbon tax price per unit CO2 discharge amount to the objective function of the first optimization problem, and the second problem creation part adds the term obtained by multiplying the CO2 discharge amount calculated based on the energy purchase amount in the second operation plan by the carbon tax price per unit CO2 discharge amount to the objective function of the second optimization problem. According to the energy operation management apparatus 4C1, the energy operation plan can be created in consideration of the carbon tax charged in accordance with the energy purchase.

When the CO2 cap-and-trade system is introduced, in the energy operation management apparatus 4C2 according to the embodiment 3, the first operation plan includes the energy purchase amount in the energy market at each time in the first period, and the second operation plan includes the energy purchase amount in the energy market at each time in the second period. The storage data includes the data of the CO2 dischargeable range allocated to the plurality of energy supply apparatuses. The limitation condition of the first optimization problem includes the condition that the CO2 discharge amount calculated based on the energy purchase amount in the first period in the plurality of apparatuses is within the CO2 dischargeable range, and the limitation condition of the second optimization problem includes the condition that the CO2 discharge amount calculated based on the energy purchase amount in the second period in the plurality of apparatuses is within the CO2 dischargeable range. According to the energy operation management apparatus 4C2, the energy operation plan can be created in consideration of the limitation of the CO2 dischargeable range.

### D. Embodiment 4

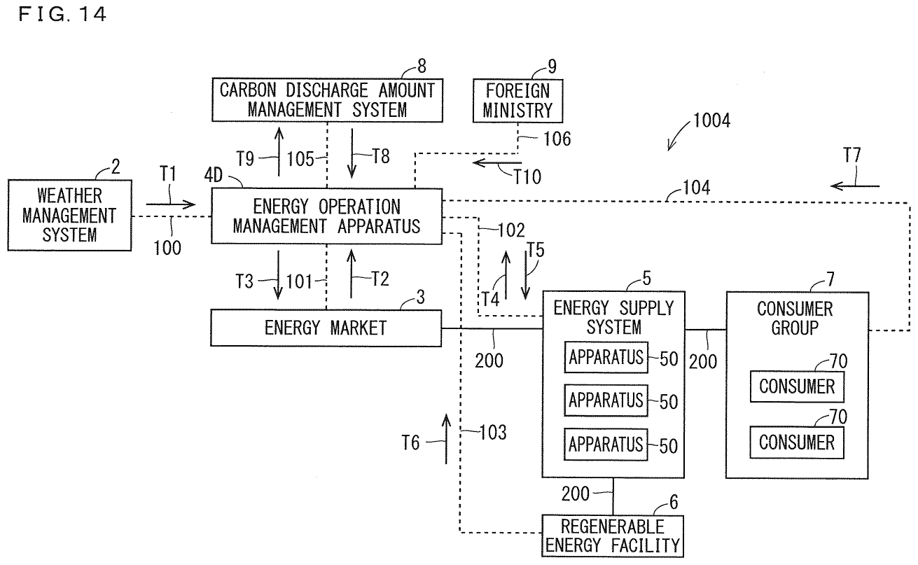

FIG. 14 is a configuration diagram of an energy operation management system 1004 according to an embodiment 4. In the energy operation management systems 1001 to 1003 according to the embodiments 1 to 3, a trend in international affairs is not considered in creating the energy operation plan. For example, when a country having a large export amount of oil etc. is hit with economic sanction from the other country due to war etc. and reduces the export amount of fuel, a fuel price may rise sharply. Thus, in the energy operation management system 1005, the energy operation plan is created in consideration of the trend in the international affairs in addition to the peculiar event caused by abnormal weather.

The energy operation management system 1004 includes a foreign ministry 9 in addition to the weather management system 2, the energy market 3, the energy operation management apparatus 4D, the energy supply system 5, the renewable energy facility 6, the consumer group 7, and the carbon discharge amount management system 8.

As illustrated in FIG. 14, the foreign ministry 9 is connected to the energy operation management apparatus 4D via a communication network 109. The foreign ministry 9 follows the trend of the international affairs such as war, and outputs information T10 regarding the international affairs to the energy operation management apparatus 4D.

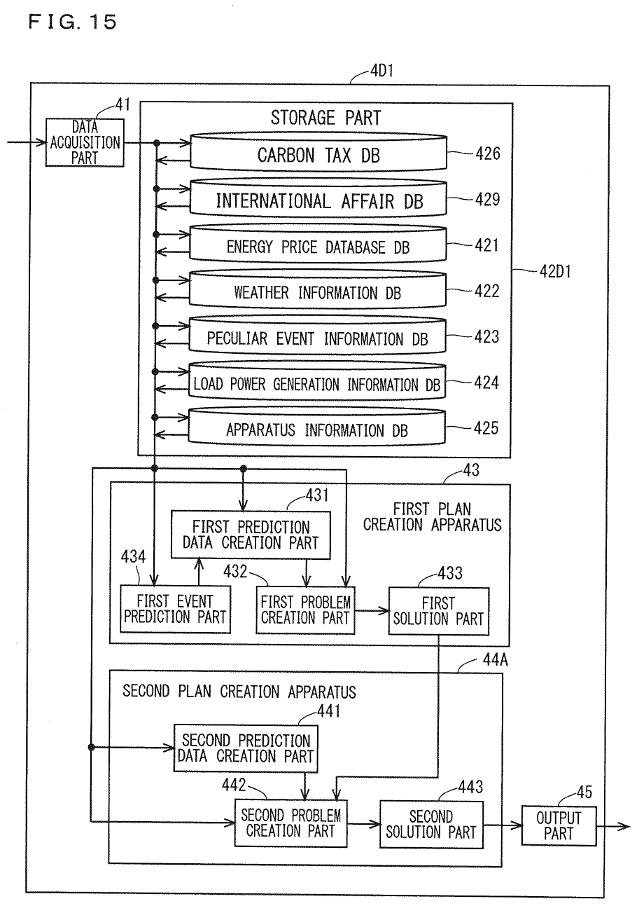

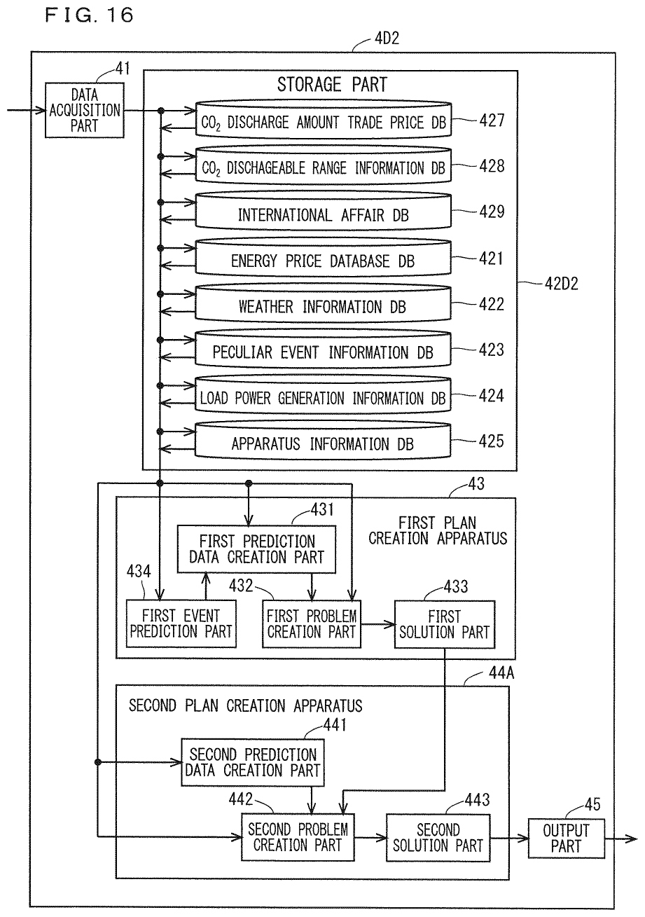

A configuration of the energy operation management apparatus 4C has two patterns of an energy operation management apparatus 4D1 illustrated in FIG. 15 and an energy operation management apparatus 4D2 illustrated in FIG. 16. The energy operation management apparatus 4D1 is applied when the carbon tax is introduced, and the energy operation management apparatus 4D2 is applied when the CO2 cap-and-trade system is introduced.

The energy operation management apparatus 4D1 includes a storage part 42D1 in place of the storage part 42C1 when compared with the energy operation management apparatus 4C1 according to the embodiment 3. The storage part 42D1 includes an international affair DB 429 in addition to the configuration of the storage part 42C1.

The energy operation management apparatus 4D2 includes a storage part 42D2 in place of the storage part 42C2 when compared with the energy operation management apparatus 4C2 according to the embodiment 3. The storage part 42D2 includes the international affair DB 429 in addition to the configuration of the storage part 42C2. The energy operation management apparatus 4D1 is described hereinafter.

The data acquisition part 41 acquires the information T10 regarding the international affair from the foreign ministry 9, and stores the information T10 in the international affair DB 429.

The first prediction data creation part 431 creates the first prediction data in consideration of the information T10 regarding the international affair.

The second prediction data creation part 441 creates the second prediction data in consideration of the information T10 regarding the international affair.

For example, the first prediction data creation part 431 and the second prediction data creation part 441 may create the prediction data of the fuel price based on a similarity between the international affair having influence on the fuel price in the past and the information T10 currently acquired by the data acquisition part 41 using the information stored in the storage part 42. However, the method of creating the first prediction data and the second prediction data is not limited thereto.

Accordingly, the first problem creation part 432 and the second problem creation part 442 can create the energy operation plan in consideration of the international affair.

A procedure of the method of creating the energy operation plan performed by the energy operation management apparatus 4D is basically as shown by the flow chart in FIG. 9. However, in Step S103, the first prediction data creation part 431 creates the first prediction data also in consideration of the data regarding the international affair stored in the international affair DB 429. Accordingly, in Step S104, the energy operation plan is created in the first period in consideration of the international affair. In Step S105, the second prediction data creation part 441 creates the second prediction data also in consideration of the data regarding the international affair stored in the international affair DB 429. Accordingly, in Step S106, the energy operation plan is created in the second period in consideration of the international affair.

In the energy operation management apparatus 4D according to the embodiment 4, the storage data stored in the storage parts 42D1 and 42D2 includes the information regarding the international affair. In the energy operation management apparatus 4D, the first prediction data and the second prediction data are created also based on the international affair. Thus, the energy operation plan can be created also in consideration of the international affair.

### E. Hardware Configuration

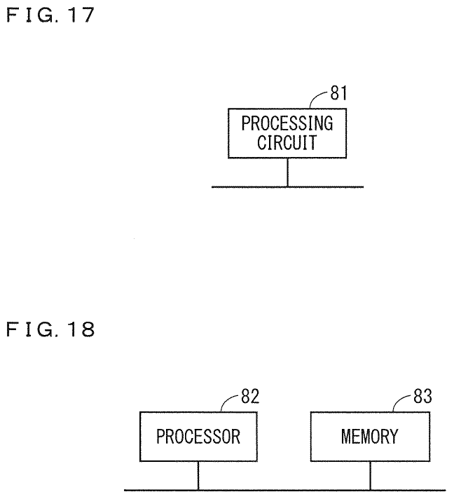

The data acquisition part 41, the storage parts 42A, 42B, 42C1, 42C2, 42D1, and 42D2, the first plan creation apparatus 43, and the second plan creation apparatuses 44A and 44B in the energy operation management apparatuses 4A, 4B, 4C1, 4C2, 4D1, and 4D2 described above are achieved by a processing circuit 81 illustrated in FIG. 17. That is to say, the processing circuit 81 includes the data acquisition part 41, the storage parts 42A, 42B, 42C1, 42C2, 42D1, and 42D2, the first plan creation apparatus 43, and the second plan creation apparatuses 44A and 44B (referred to as the data acquisition part 41 etc. hereinafter). Dedicated hardware may be applied to the processing circuit 81, or a processer executing a program stored in a memory may also be applied. Examples of the processor include a central processing unit, a processing device, an arithmetic device, a microprocessor, a microcomputer, or a digital signal processor (DSP).

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81. Each function of the data acquisition part 41 etc. may be achieved by the plurality of processing circuits 81, or each function of them may also be collectively achieved by one processing circuit.

When the processing circuit 81 is the processor, the function of the data acquisition part 41 etc. is achieved by a combination with software etc. (software, firmware, or software and firmware). The software etc. is described as a program and is stored in a memory. As illustrated in FIG. 18, a processor 82 applied to the processing circuit 81 reads out and executes a program stored in the memory 83, thereby achieving the function of each unit. That is to say, the energy operation management apparatuses 4A, 4B, 4C1, 4C2, 4D1, and 4D2 include the memory 83 for storing programs to resultingly execute processing of each part of the data acquisition part 41 etc. when executed by the processing circuit 81. In other words, this program is also deemed to make a computer execute a procedure or a method of the data acquisition part 41 etc. Herein, the memory 83 may be a non-volatile or volatile semiconductor memory such as a RAM (Random Access Memory), a ROM (Read Only Memory), a flash memory, an EPROM (Electrically Programmable Read Only Memory), or an EEPROM (Electrically Erasable Programmable Read Only Memory), an HDD (Hard Disk Drive), a magnetic disc, a flexible disc, an optical disc, a compact disc, a mini disc, a DVD (Digital Versatile Disc), or a drive device of them, or any storage medium which is to be used in the future.

Described above is the configuration that each function of the data acquisition part 41 etc. is achieved by one of the hardware and the software, for example. However, the configuration is not limited thereto, but also applicable is a configuration of achieving a part of the data acquisition part 41 etc. by dedicated hardware and achieving another part of them by software, for example.

As described above, the processing circuit can achieve each function described above by the hardware, the software, or the combination of them, for example. The storage parts 42A, 42B, 42C1, 42C2, 42D1, and 42D2 are made up of the memory 83.

Each embodiment can be arbitrarily combined, or each embodiment can be appropriately varied or omitted. The foregoing description is in all aspects illustrative. It is therefore understood that numerous modification examples not illustrated can be devised.

### EXPLANATION OF REFERENCE SIGNS

2 weather management system, 3 energy market, 4A, 4B, 4C, 4C1, 4C2, 4D1, 4D2 energy operation management apparatus, 5 energy supply system, 6 renewable energy facility, 7 consumer group, 8 carbon discharge amount management system, 9 foreign ministry, 31 JEPX, 32 retail electricity provider, 33 gas company, 41 data acquisition part, 42, 42A, 42B, 42C1, 42C2, 42D1, 42D2 storage part, 43 first plan creation apparatus, 44A, 44B second plan creation apparatus, 45 output part, 50 apparatus, 70 consumer, 81 processing circuit, 82 processor, 83 memory, 100, 101, 102, 103, 104, 105, 109 communication network, 200 infrastructure facility, 431 first prediction data creation part, 432 first problem creation part, 433 first solution part, 434 first event prediction part, 441 second prediction data creation part, 442 second problem creation part, 443 second solution part, 444 second event prediction part, 1001, 1002, 1003, 1004, 1005 energy operation management system.

1. An energy operation management apparatus creating an operation plan of a plurality of energy supply apparatuses supplying energy to a consumer group using generated electrical power in a renewable energy facility and energy bought from an energy market, the energy operation management apparatus, comprising:
a processor to execute a program; and
a memory to store the program, which executed by the processor, performs processes of:
acquiring storage data including an actual value of an energy price in the energy market, an energy demand of the consumer group, generated electrical power of the renewable energy facility, and weather data;
predicting whether a peculiar event as a phenomenon having influence on at least any one of the energy price, the energy demand, and the generated electrical power occurs in a first period based on the storage data;
predicting at least any one of the energy price, the energy demand, and the generated electrical power in the first period as first prediction data based on the storage data and first event prediction data as a prediction result of occurrence of the peculiar event in the first period;
creating a first optimization problem for determining a first operation plan as an operation plan of the plurality of energy supply apparatuses in the first period based on the storage data and the first prediction data;
obtaining the solution of the first optimization problem, thereby determining the first operation plan;
predicting at least any one of the energy price, the energy demand, and the generated electrical power in a second period shorter than the first period as second prediction data based on the storage data;
creating a second optimization problem for determining a second operation plan as an operation plan of the plurality of energy supply apparatuses in the second period based on the storage data, the second prediction data, and the first operation plan;
obtaining a solution of the second optimization problem, thereby determining the second operation plan; and
performing an energy purchase request to the energy market based on the second operation plan and transmitting instruction of an operation to the plurality of energy supply apparatuses.

2. The energy operation management apparatus according to claim 1, wherein
the program, when executed by the processor, performs processes of:
updating the first event prediction data with a cycle shorter than the first period;
updating the first prediction data based on the first event prediction data which has been updated and the storage data;
updating the first optimization problem based on the storage data and the first prediction data which has been updated;
obtaining the solution of the first optimization problem which has been updated, thereby updating the first operation plan;
updating the second prediction data with a cycle shorter than the second period;
updating the second optimization problem based on the storage data and the second prediction data which has been updated; and
obtaining the solution of the second optimization problem which has been updated, thereby updating the second operation plan.

3. The energy operation management apparatus according to claim 1, wherein
the program, when executed by the processor, performs processes of:
creating plural pieces of the first prediction data having a different probability of occurrence for each time in the first period; and
creating plural pieces of the second prediction data having a different probability of occurrence for each time in the second period.

4. The energy operation management apparatus according to claim 1, wherein
the energy demand includes an electrical power demand and a heat demand.

5. The energy operation management apparatus according to claim 1, wherein
the program, when executed by the processor, further performs processes of:
predicting whether the peculiar event occurs in the second period based on the storage data; and
creating the second prediction data based on the storage data and the second event prediction data as a prediction result of occurrence of the peculiar event in the second period.

6. The energy operation management apparatus according to claim 1, wherein
the first operation plan includes an energy purchase amount in the energy market at each time in the first period,
the second operation plan includes an energy purchase amount in the energy market at each time in the second period,
the storage data includes data of a carbon tax price per unit CO2 discharge amount, and
the program, when executed by the processor, performs processes of:
adding a term obtained by multiplying a CO2 discharge amount calculated based on the energy purchase amount in the first operation plan by the carbon tax price per unit CO2 discharge amount to an objective function of the first optimization problem; and
adding a term obtained by multiplying a CO2 discharge amount calculated based on the energy purchase amount in the second operation plan by the carbon tax price per unit CO2 discharge amount to an objective function of the second optimization problem.

7. The energy operation management apparatus according to claim 1, wherein
the first operation plan includes an energy purchase amount in the energy market at each time in the first period,
the second operation plan includes an energy purchase amount in the energy market at each time in the second period,
the storage data includes data of a CO2 dischargeable range allocated to the plurality of energy supply apparatuses,
a limitation condition of the first optimization problem includes a condition that a CO2 discharge amount calculated based on the energy purchase amount in the first period in the plurality of apparatuses is within the CO2 dischargeable range, and
a limitation condition of the second optimization problem includes a condition that a CO2 discharge amount calculated based on the energy purchase amount in the second period in the plurality of apparatuses is within the CO2 dischargeable range.

8. The energy operation management apparatus according to claim 7, wherein
the storage data includes data of an actual value of a CO2 discharge amount trade price,
the objective function of the first optimization problem includes a term obtained by multiplying a difference between the CO2 discharge amount and the CO2 dischargeable range calculated based on the energy purchase amount in the first period by the CO2 discharge amount trade price in the first period,
the objective function of the second optimization problem includes a term obtained by multiplying a difference between the CO2 discharge amount and the CO2 dischargeable range calculated based on the energy purchase amount in the second period by the CO2 discharge amount trade price in the second period, and
the program, when executed by the processor, performs processes of:
predicting the CO2 discharge amount trade price in the first period based on the storage data and the first event prediction data; and
predicting the CO2 discharge amount trade price in the second period based on the storage data.

9. The energy operation management apparatus according to claim 7, wherein
the storage data includes information regarding an international affair.

10. An energy operation management method of creating an operation plan of a plurality of energy supply apparatuses supplying energy to a consumer group using generated electrical power in a renewable energy facility and energy bought from an energy market, the energy operation management method, comprising:
acquiring storage data including an actual value of an energy price in the energy market, an energy demand of the consumer group, generated electrical power of the renewable energy facility, and weather data, and making a storage part store the storage data;
predicting whether a peculiar event as a phenomenon having influence on at least any one of the energy price, the energy demand, and the generated electrical power occurs in the first period based on the storage data;
predicting at least any one of the energy price, the energy demand, and the generated electrical power in the first period as first prediction data based on the storage data and first event prediction data as a prediction result of occurrence of the peculiar event in the first period;
creating a first optimization problem for determining a first operation plan as an operation plan of the plurality of energy supply apparatuses in the first period based on the storage data and first prediction data;
obtaining a solution of the first optimization problem, thereby determining the first operation plan;
predicting at least any one of the energy price, the energy demand, and the generated electrical power in a second period shorter than the first period as second prediction data based on the storage data;
creating a second optimization problem for determining a second operation plan as an operation plan of the plurality of energy supply apparatuses in the second period based on the storage data and second prediction data;
obtaining a solution of the second optimization problem, thereby determining the second operation plan; and
performing an energy purchase request to the energy market based on the second operation plan and transmitting instruction of an operation to the plurality of energy supply apparatuses.
